(19) United States
(12) Patent Application Publication
(10) Pub. No.: US 2024/0168132 A1
(43) Pub. Date: May 23, 2024

(54) ELECTROMAGNETIC WAVE TRANSMISSIVE COVER AND SENSOR MODULE

(71) Applicant: TOYODA GOSEI CO., LTD., Kiyosu-shi (JP)

(72) Inventors: Risa HIRANO, Kiyosu-shi (JP); Koji FUKAGAWA, Kiyosu-shi (JP); Yosuke TSUCHIYA, Kiyosu-shi (JP)

(21) Appl. No.: 18/505,343

(22) Filed: Nov. 9, 2023

(30) Foreign Application Priority Data
Nov. 18, 2022 (JP) 2022-185218

(51) Int. Cl. G01S 7/481

(52) U.S. Cl. CPC G01S 7/4811

(57) ABSTRACT

An electromagnetic wave transmissive cover is configured to be employed in a vehicle equipped with a sensor device. The sensor device is configured to transmit an electromagnetic wave in a transmission direction. The sensor device is arranged in a front end or a rear end of a roof of the vehicle. One of the front end and the rear end in which the sensor device is arranged includes an inclined surface. The inclined surface includes an opening. The electromagnetic wave transmissive cover includes a cover body arranged to close the opening of the inclined surface. The cover body extends along the inclined surface and is inclined with respect to the transmission direction. An anti-reflective portion is arranged on at least one of two surfaces of the cover body in the transmission direction to reduce reflection of the electromagnetic wave.

### BACKGROUND

### 1. Field

The present disclosure relates to an electromagnetic wave transmissive cover that covers a sensor device attached to the roof of a vehicle from the front in a direction in which electromagnetic waves are transmitted and to a sensor module including the sensor device and the electromagnetic wave transmissive cover.

### 2. Description of Related Art

Japanese Laid-Open Patent Publication No. 2016-150624 discloses a typical example of such a sensor module. Such a sensor module includes a sensor incorporated in an aerodynamically-shaped front end of a roof rail of a vehicle and an aerodynamically-shaped cover integrated with the front end. The sensor is located on the rear side of the cover. This configuration provides the effect of reducing the air resistance during traveling of the vehicle and improves the aesthetic appeal of the vehicle.

In the sensor module, the effect is obtained when the sensor is, for example, an infrared sensor. However, the cover is arranged diagonally relative to a direction in which infrared rays are transmitted. This increases the angle of incidence of an infrared ray on the cover and thus increases the amount of reflection of infrared rays by the cover. As a result, the transmittivity of infrared rays through the cover decreases. Accordingly, the detection accuracy of the infrared sensor decreases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An electromagnetic wave transmissive cover according to an aspect of the present disclosure is configured to be employed in a vehicle equipped with a sensor device configured to transmit and receive an electromagnetic wave. The sensor device is configured to transmit the electromagnetic wave in a transmission direction. The sensor device is arranged in a front end or a rear end of a roof of the vehicle. One of the front end and the rear end in which the sensor device is arranged includes an inclined surface. The inclined surface includes an opening and is located forward of the sensor device in the transmission direction. The electromagnetic wave transmissive cover includes a cover body arranged to close the opening of the inclined surface. The cover body extends along the inclined surface and is inclined with respect to the transmission direction. The electromagnetic wave transmissive cover further includes an anti-reflective portion arranged on at least one of two surfaces of the cover body in the transmission direction. The anti-reflective portion reduces reflection of the electromagnetic wave.

A sensor module according to an aspect of the present disclosure includes a sensor device arranged in a front end or a rear end of a roof of a vehicle and configured to transmit and receive an electromagnetic wave. The sensor device is configured to transmit the electromagnetic wave in a transmission direction. One of the front end and the rear end in which the sensor device is arranged includes an inclined surface. The inclined surface includes an opening and is located forward of the sensor device in the transmission direction. The sensor module further includes an electromagnetic wave transmissive cover arranged to close the opening of the inclined surface. The electromagnetic wave transmissive cover extends along the inclined surface and is inclined with respect to the transmission direction. The sensor module further includes an anti-reflective portion arranged on at least one of two surfaces of the electromagnetic wave transmissive cover in the transmission direction. The anti-reflective portion reduces reflection of the electromagnetic wave.

Other features and aspects will be apparent from the following detailed description, the drawings, and the claims.

### BRIEF DESCRIPTION OF DRAWINGS

FIG. 1 is a perspective view showing part of a vehicle according to an embodiment.

FIG. 2 is a schematic cross-sectional view illustrating the main part of FIG. 1.

FIG. 3 is a schematic cross-sectional view of the sensor module.

FIG. 4 is a graph showing the result of measuring the relationship between the angle of incidence of an electromagnetic wave and the transmittance of the electromagnetic wave in example 1 and comparative example 1.

FIG. 5 is a schematic cross-sectional view showing the cover body of the electromagnetic wave transmissive cover according to a modification.

FIG. 6 is a schematic cross-sectional view showing the cover body of the electromagnetic wave transmissive cover according to another modification.

FIG. 7 is a schematic cross-sectional view showing the cover body of the electromagnetic wave transmissive cover according to a further modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the modes, apparatuses, and/or systems described. Modifications and equivalents of the modes, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A sensor module mounted on a vehicle according to an embodiment will now be described with reference to the drawings.

The direction in which the vehicle travels forward is hereinafter referred to as the front. The reverse direction is hereinafter referred to as the rear. The up-down direction refers to the up-down direction of the vehicle, and the left-right direction refers to a vehicle width direction that coincides with the left-right direction when the vehicle is traveling forward.

Vehicle 11

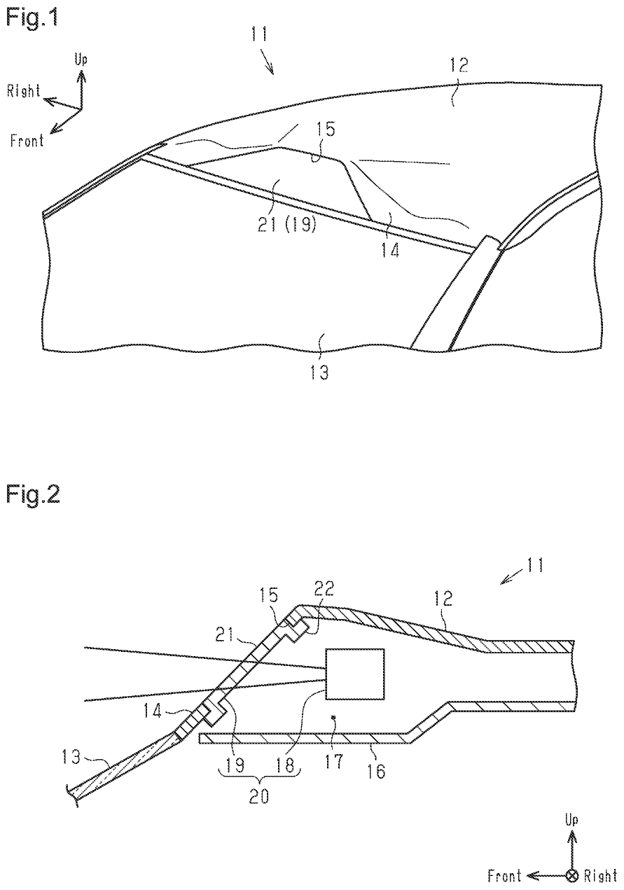

As shown in FIG. 1, a vehicle 11 includes a roof panel 12, which is an example of a roof, and a windshield 13 that is located in front of and adjacent to the roof panel 12. The front end of the roof panel 12 includes an inclined surface 14. The inclined surface 14 is connected to the windshield 13 and lowers toward the front. The inclined surface 14 may be flat or curved.

As shown in FIGS. 1 and 2, an opening 15 is formed at a middle portion of the inclined surface 14 at the front end of the roof panel 12 in the vehicle width direction (left-right direction). The opening 15 has the shape of an isosceles trapezoid in which the lower base is longer than the upper base. A ceiling panel 16 is arranged on the inner side (lower side) of the roof panel 12 to define a ceiling of the passenger compartment. A space 17 is created between the ceiling panel 16 and the roof panel 12. The front end of the space 17 in the vehicle 11 is equipped with a sensor module 20 that includes a sensor device 18 and an electromagnetic wave transmissive cover 19.

Sensor Device 18

As shown in FIG. 2, the sensor device 18 is arranged on the inner side (lower side) of the front end of the roof panel 12 and rearward of the inclined surface 14. The sensor device 18 faces the opening 15, which is formed in the inclined surface 14, in the front-rear direction. In this example, the sensor device 18 is a front-monitoring near-infrared sensor.

Of electromagnetic waves, the near-infrared sensor transmits near-infrared rays toward the front of the vehicle 11 that have a wavelength of between 800 nm and 1700 nm, inclusive, and receives the near-infrared rays that have struck and have been reflected by an object outside the vehicle including, for example, its leading vehicle and pedestrians. Based on the transmitted and received electromagnetic waves (near-infrared rays), the sensor device 18 recognizes the object outside the vehicle and detects, for example, the distance between the vehicle 11 and the object and the relative speed.

As described above, the sensor device 18 transmits electromagnetic waves (near-infrared rays) toward the front of the vehicle 11. Thus, the direction in which electromagnetic waves are transmitted by the sensor device 18 is the direction from the rear toward the front of the vehicle 11. The front in the transmission direction of electromagnetic waves substantially matches the front of the vehicle 11. The rear in the transmission direction also substantially matches the rear of the vehicle 11. Thus, in the following description, the front in the transmission direction of electromagnetic waves is simply referred to as “forward” or “front,” and the rear in the transmission direction is simply referred to as “rearward” or “rear.”

Electromagnetic Wave Transmissive Cover 19

As shown in FIGS. 1 and 2, the electromagnetic wave transmissive cover 19 includes a cover body 21 and a flange 22. The cover body 21 closes the opening 15. The flange 22 protrudes outward from the edge of the cover body 21 with a step. The cover body 21 has the shape of an isosceles trapezoid that corresponds to the opening 15 of the inclined surface 14.

The electromagnetic wave transmissive cover 19 is coupled to the inclined surface 14 by joining, using adhesive or the like, the flange 22 to the inner surface of the inclined surface 14 with the cover body 21 fitted to the opening 15 of the inclined surface 14 from the inner side. The cover body 21 is arranged to close the opening 15 in the inclined surface 14, which is located forward of the sensor device 18 in the transmission direction of electromagnetic waves. Thus, the cover body 21 is located at the middle portion of the inclined surface 14 at the front end of the roof panel 12 in the vehicle width direction (left-right direction).

The outer surface of the cover body 21 is flush with the outer surface of the inclined surface 14. The cover body 21 extends along the inclined surface 14 and is inclined with respect to the transmission direction (in this example, the front-rear direction) of electromagnetic waves in the sensor device 18. In this case, the angle formed between the cover body 21 and the horizontal plane is set to be between 20 degrees and 80 degrees, inclusive. The cover body 21 is also used as a garnish that decorates the front end of the roof panel 12 of the vehicle 11, in addition to covering the sensor device 18 from the front.

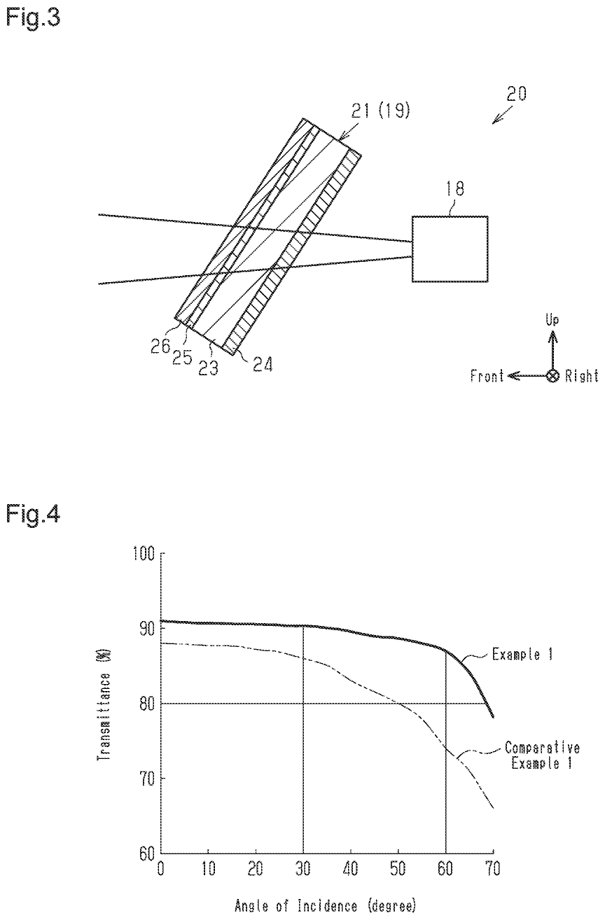

As shown in FIG. 3, the cover body 21 of the electromagnetic wave transmissive cover 19 includes a base layer 23. The base layer 23 is made of, for example, an acrylic resin, a polycarbonate resin, or an ABS resin. A hard coating layer 24 is arranged on the surface of the base layer 23 that faces the sensor device 18 in the transmission direction of electromagnetic waves (i.e., on the rear surface of the base layer 23). The hard coating layer 24 is made of, for example, an acrylic paint.

An anti-reflective layer 26 is arranged on the surface of the base layer 23 opposite from the sensor device 18 in the transmission direction of electromagnetic waves (i.e., on the front surface of the base layer 23), with the binder layer 25 located between the base layer 23 and the anti-reflective layer 26. The anti-reflective layer 26 serves as an anti-reflective portion. The binder layer 25 is made of, for example, an acrylic paint. The anti-reflective layer 26 reduces reflection of the electromagnetic waves (near-infrared rays). The anti-reflective layer 26 is formed using, for example, a transparent thin film that is made of MgF₂ (magnesium fluoride) and has a relatively low refractive index.

FIG. 4 is a graph showing the result of measuring the relationship between the angle of incidence and the transmittance when electromagnetic waves are emitted in electromagnetic wave transmissive covers. In FIG. 4, the solid line indicates the measurement result for the electromagnetic wave transmissive cover 19 of example 1 including the cover body 21 with the anti-reflective layer 26. In FIG. 4, the long dashed double-short dashed line indicates the measurement result for an electromagnetic wave transmissive cover of comparative example 1 including a cover body without the anti-reflective layer 26.

As described above, the electromagnetic wave transmissive cover 19 of example 1 includes a four-layer laminate of the hard coating layer 24, the base layer 23, the binder layer 25, and the anti-reflective layer 26. The electromagnetic wave transmissive cover of comparative example 1 includes a two-layer laminate of the hard coating layer 24 and the base layer 23.

The following can be understood from the graph in FIG. 4. In both of example 1 and comparative example 1, the transmittance decreases as the angle of incidence increases. Example 1 generally has a higher transmittance than comparative example 1 regardless of the angle of incidence. Example 1 satisfies a required value, that is, a transmittance of 80% or greater for an electromagnetic wave when the electromagnetic wave is emitted at the angle of incidence between 30 degrees and 60 degrees, inclusive. In comparative example 1, the transmittance of the electromagnetic wave is below 80% from approximately the point where the angle of incidence of the electromagnetic wave exceeds 50 degrees. That is, comparative example 1 does not satisfy the required value.

In this manner, the cover body 21 of the electromagnetic wave transmissive cover 19 includes the anti-reflective layer 26. In such a configuration, even if the angle of incidence of an electromagnetic wave is increased, a decrease in the transmittance of the electromagnetic wave is effectively limited as compared to a configuration without the anti-reflective layer 26.

### Operation of Embodiment

In general, if the cover body 21 is arranged upright on the inclined surface 14 of the roof panel 12 of the vehicle 11 to reduce the angle of incidence of an electromagnetic wave from the sensor device 18, the transmittivity of the electromagnetic wave through the cover body 21 is improved. However, the amount of protrusion of the cover body 21 from the roof panel 12 is increased so that the aesthetic appeal of the vehicle 11 decreases.

If the cover body 21 is laid along the inclined surface 14 of the roof panel 12 to improve the aesthetic appeal of the vehicle 11, the angle of incidence of an electromagnetic wave from the sensor device 18 relative to the cover body 21 increases. This increases the amount of the electromagnetic wave reflected by the cover body 21 and thus lowers the transmittivity of the electromagnetic wave through the cover body 21. As a result, the detection accuracy of the sensor device 18 is insufficient.

In the above embodiment, although the cover body 21 is laid out along the inclined surface 14 to improve the aesthetic appeal of the vehicle 11, the anti-reflective layer 26 reduces reflection of an electromagnetic wave from the sensor device 18 on the cover body 21. Thus, the transmittivity of the electromagnetic wave from the sensor device 18 through the cover body 21 is sufficient. This improves the detection accuracy of the sensor device 18, while improving the aesthetic appeal of the vehicle 11.

### Advantages of Embodiment

The embodiment described above in detail has the following advantages.

(1) In the electromagnetic wave transmissive cover 19, the cover body 21 extends along the inclined surface 14 and is inclined with respect to the transmission direction of electromagnetic waves from the sensor device 18. The cover body 21 includes the anti-reflective layer 26 on the front surface in the transmission direction to reduce reflection of electromagnetic waves.

In this configuration, even if the cover body 21 is laid out along the inclined surface 14 to improve the aesthetic appeal of the vehicle 11, the anti-reflective layer 26 reduces reflection of electromagnetic waves on the cover body 21. Thus, the transmittivity of electromagnetic waves through the cover body 21 is sufficient. This improves the detection accuracy of the sensor device 18, while improving the aesthetic appeal of the vehicle 11. In addition, the cover body 21 laid out along the inclined surface 14 reduces the air resistance during traveling of the vehicle 11.

(2) In the electromagnetic wave transmissive cover 19, the cover body 21 includes the base layer 23. The anti-reflective layer 26 is arranged on the surface of the base layer 23 opposite from the sensor device 18 in the transmission direction, with the binder layer 25 located between the base layer 23 and the anti-reflective layer 26.

Normally, if the anti-reflective layer 26 is directly arranged on the base layer 23 when there is a difference in the coefficient of thermal expansion between the base layer 23 and the anti-reflective layer 26, cracks may occur in the expansion of these members. In the above configuration, the anti-reflective layer 26 is arranged on the base layer 23, with the binder layer 25 located between the base layer 23 and the anti-reflective layer 26. Thus, even if the coefficient of thermal expansion differs between the base layer 23 and the anti-reflective layer 26, the difference that occurs during the expansion of these members is absorbed by the binder layer 25. This limits the occurrence of cracks that would be caused by the difference in the coefficient of thermal expansion between the base layer 23 and the anti-reflective layer 26.

(3) In the electromagnetic wave transmissive cover 19, the transmittance of the cover body 21 is 80% or greater when electromagnetic waves (near-infrared rays) each having a wavelength between 800 nm and 1700 nm, inclusive, are emitted at the angle of incidence between 30 degrees and 60 degrees, inclusive.

In this configuration, the cover body 21 has a transmittance of 80% or greater when the electromagnetic waves used in the sensor device 18 each have an angle of incidence between 30 degrees and 60 degrees, inclusive. This further ensures the detection accuracy of the sensor device 18.

(4) The angle between the cover body 21 of the electromagnetic wave transmissive cover 19 and the horizontal plane is set to be between 20 degrees and 80 degrees, inclusive.

This configuration limits the height of the cover body 21 and thus improves the aesthetic appeal of the vehicle 11.

(5) In the electromagnetic wave transmissive cover 19, the cover body 21 is located at the middle portion of the inclined surface 14 at the front end of the roof panel 12 in the vehicle width direction.

In this configuration, the cover body 21 is arranged relative to the inclined surface 14 in a well-balanced manner. This further improves the aesthetic appeal of the vehicle 11.

### Modifications

The above embodiments may be modified as follows. The above embodiment and the following modifications can be combined as long as the combined modifications remain technically consistent with each other.

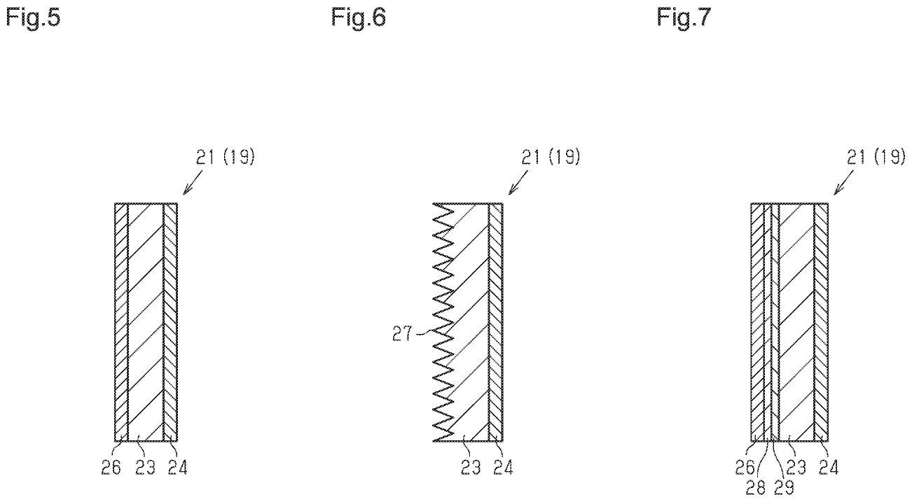

As shown in FIG. 5, the binder layer 25 may be omitted from the cover body 21.

As shown in FIG. 6, the anti-reflective layer 26 and the binder layer 25 may be omitted from the cover body 21, and a concave-convex portion 27 may be formed as the anti-reflective portion on the entire surface of the base layer 23 opposite from the hard coating layer 24.

As shown in FIG. 7, in the cover body 21, the binder layer 25 may be replaced by a film layer 28 and an adhesive layer 29. In this case, the film layer 28, having the anti-reflective layer 26 on the front surface and the adhesive layer 29 on the rear surface, is bonded to the base layer 23 with the adhesive layer 29 located between the film layer 28 and the base layer 23.

The cover body 21 may be made of glass.

The cover body 21 does not have to include the anti-reflective layer 26 on the front surface and may include the anti-reflective layer 26 on the rear surface in the transmission direction of electromagnetic waves from the sensor device 18. In this case, the cover body 21 has a structure in which the base layer 23, the hard coating layer 24, and the anti-reflective layer 26 are laminated in this order from the front surface toward the rear surface. Further, the hard coating layer 24 may be replaced with the binder layer 25.

The cover body 21 may include the anti-reflective layer 26 on each of the two surfaces of the cover body 21 in the transmission direction of electromagnetic waves from the sensor device 18. In this case, the cover body 21 has a structure in which the anti-reflective layer 26, the binder layer 25, the base layer 23, the hard coating layer 24, and the anti-reflective layer 26 are laminated in this order from the front surface toward the rear surface. Further, the hard coating layer 24 may be replaced with the binder layer 25.

The roof is not limited to the roof panel 12 and may be a roof rail.

The cover body 21 may be arranged at the end of the inclined surface 14 at the front end of the roof panel 12 in the vehicle width direction.

The angle formed between the cover body 21 and the horizontal plane does not need to be set to be between 20 degrees and 80 degrees, inclusive.

The wavelength of an electromagnetic wave used in the sensor device 18 does not have to be between 800 nm and 1700 nm, inclusive.

The cover body 21 does not need to have a transmittance of 80% or greater for an electromagnetic wave when the electromagnetic wave is emitted at the angle of incidence between 30 degrees and 60 degrees, inclusive.

The electromagnetic wave transmitted and received by the sensor device 18 may include a millimeter wave in addition to a near-infrared ray. When the electromagnetic wave is a millimeter wave, a millimeter wave radar device is used as the sensor device 18.

The sensor device 18 that transmits and receives electromagnetic waves used to detect an object outside the vehicle does not have to be a front-monitoring device and may be a rear-monitoring device. In this case, the sensor device 18 is arranged on the inner side of the inclined surface at the rear end of the roof panel 12. That is, the inclined surface at the rear end of the roof panel 12 is located forward of the sensor device 18 in the transmission direction of electromagnetic waves. Further, the electromagnetic wave transmissive cover 19 is located at the opening of the inclined surface at the rear end of the roof panel 12.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An electromagnetic wave transmissive cover configured to be employed in a vehicle equipped with a sensor device configured to transmit and receive an electromagnetic wave, the sensor device being configured to transmit the electromagnetic wave in a transmission direction, the sensor device being arranged in a front end or a rear end of a roof of the vehicle, one of the front end and the rear end in which the sensor device is arranged including an inclined surface, and the inclined surface including an opening and being located forward of the sensor device in the transmission direction, the electromagnetic wave transmissive cover comprising:
a cover body arranged to close the opening of the inclined surface, the cover body extending along the inclined surface and being inclined with respect to the transmission direction; and
an anti-reflective portion arranged on at least one of two surfaces of the cover body in the transmission direction, the anti-reflective portion reducing reflection of the electromagnetic wave.

2. The electromagnetic wave transmissive cover according to claim 1, wherein
the cover body includes a base layer, and
an anti-reflective layer is arranged on a surface of the base layer opposite from the sensor device in the transmission direction with a binder layer located between the anti-reflective layer and the base layer, the anti-reflective layer serving as the anti-reflective portion.

3. The electromagnetic wave transmissive cover according to claim 1, wherein
the wavelength of the electromagnetic wave is between 800 nm and 1700 nm, inclusive, and
the cover body has a transmittance of 80% or greater for the electromagnetic wave when the electromagnetic wave is emitted at an angle of incidence between 30 degrees and 60 degrees, inclusive.

4. The electromagnetic wave transmissive cover according to claim 3, wherein an angle formed between the cover body and a horizontal plane is set to be between 20 degrees and 80 degrees, inclusive.

5. The electromagnetic wave transmissive cover according to claim 1, wherein
the roof is a roof panel,
the inclined surface is located at a front end of the roof panel, and
the cover body is located at a middle portion of the inclined surface at the front end of the roof panel in a vehicle width direction.

6. A sensor module, comprising:
a sensor device arranged in a front end or a rear end of a roof of a vehicle and configured to transmit and receive an electromagnetic wave, the sensor device being configured to transmit the electromagnetic wave in a transmission direction, one of the front end and the rear end in which the sensor device is arranged including an inclined surface, and the inclined surface including an opening and being located forward of the sensor device in the transmission direction;
an electromagnetic wave transmissive cover arranged to close the opening of the inclined surface, the electromagnetic wave transmissive cover extending along the inclined surface and being inclined with respect to the transmission direction; and
an anti-reflective portion arranged on at least one of two surfaces of the electromagnetic wave transmissive cover in the transmission direction, the anti-reflective portion reducing reflection of the electromagnetic wave.
